(19) United States
(12) Patent Application Publication
(10) Pub. No.: US 2010/0281950 A1
(43) Pub. Date: Nov. 11, 2010

(54) METHOD AND APPARATUS FOR ANALYSIS OF MIXED STREAMS

(76) Inventor: Oleh Weres, Gardenerville, NV (US)

Correspondence Address: Capitol City TechLaw, PLLC, PO BOX 1210, VIENNA, VA, 22183, US

(21) Appl. No.: 12/776,192

(22) Filed: May 7, 2010

Related U.S. Application Data
(60) Provisional application No. 61/176,257, filed on May 7, 2009.

(51) Int. Cl. G01N 7/00

(52) U.S. Cl. 73/31.07

(57) ABSTRACT

Disclosed are an integrated analytical system and a method of operating the system to obtain improved control over processes that involve or produce mixed streams of gas and liquid or streams of condensable and non-condensable gases. The systems include an intake module configured for receiving and/or generating a mixed stream of liquid and gas, a pretreatment module for adding a reagent to form a treated stream, a gas purge module for stripping the treated stream and separating the treated stream into a liquid stream and a gas stream, a liquid level cell and an associated controller for maintaining a substantially constant volume of the liquid stream within the cell, parametric test modules for receiving and analyzing the liquid and gas streams and a data acquisition element for collecting parametric test data from the parametric test modules.

### PRIORITY STATEMENT

This application claims priority from U.S. Prov. Pat. Appl. No. 61/176,257, the contents of which are hereby incorporated, in their entirety, by reference.

### TECHNICAL FIELD

A field method, device and system are provided for quantitatively and rapidly determining the status of a variety of significant chemical constituents and parameters associated with mixed streams of liquid and gas including, for example, geothermal steam and geothermal steam condensate. As will be appreciated by those skilled in the art, the method, apparatus and system disclosed herein may be adapted for analyzing mixed liquid and vapor compositions in other industrial and environmental contexts including, for example, aqueous vapors and condensates generating in connection with chemical manufacturing, petroleum refining and synthetic fuel production.

### BACKGROUND OF THE INVENTION

Geothermal steam and/or its associated condensate typically include a variety of constituents and exhibit a range of parameters that are of varying degrees of concern in the context of exploitation of geothermal energy. Conventional geothermal installations will include procedures for the quantitative monitoring of some or all of these constituents and parameters including, for example, the aggregate amount of gases remaining in the gas phase in relation to the amount of liquid condensate after the steam is condensed (the non-compressible gas ratio (NCG Ratio); the conductivity of the condensate, the pH of the condensate, the aggregate amount of relatively insoluble and unreactive gases (typically including nitrogen, argon, methane and hydrogen) as well as more soluble and/or reactive gases (typically carbon dioxide, hydrogen sulfide, ammonia and hydrogen chloride).

Conventional practice in the geothermal industry involves condensing a sample of the steam on site using a small condenser (typically a coil of stainless steel tubing in a bucket of water and ice) with the resulting two phase samples being collected in suitable sample bombs. These sample bombs are, in turn, sent to one or more on-site and/or off-site laboratories for the requisite chemical analysis. The associated collection, transportation, testing and reporting activities can significantly delay receipt of the test data by field operations personnel. Indeed, in some instances complete analytical results may not be routinely available for weeks or even months.

The delays in obtaining the desired analytical data from the steam analysis can severely limit the ability to field personnel to determine if a good sample has been collected or if another sample needs to be collected. These delays in receiving analytical data can be particularly problematic with regard to samples taken while wells are being drilled or tested given the unpredictable nature of the resulting mixed streams. As will be appreciated, substantially “real time” analytical results would be quite beneficial in guiding drilling operations or determining the results of operational testing and will tend to reduce the costs associated with remote testing.

For example, the real time analysis of the mixed stream of condensate and a gas phase primarily comprising a mixture of noncondensable gas (NCG) ejected from the condenser and produced by a steam-cycle geothermal power plant will be particularly beneficial in monitoring atmospheric hydrogen sulfide emissions and the performance of hydrogen sulfide abatement efforts. As will be appreciated, the real time analysis will be helpful in monitoring the performance and/or abatement efforts with respect to volatile and/or soluble constituents in streams associated with other chemical processes.

### BRIEF SUMMARY OF THE DISCLOSURE

Disclosed are an integrated analytical system and a method of operating the system to obtain improved control over processes that involve or produce mixed streams of gas and liquid or streams of condensable and non-condensable gases. The systems include an intake module configured for receiving and/or generating a mixed stream of liquid and gas, at least one pretreatment module configured for mixing a reagent with the mixed stream to form a treated stream, at least one gas purge module for stripping the treated stream with a first purge gas to separate the treated stream into a liquid stream and a gas stream, a liquid level cell and an associated controller for receiving the liquid stream and maintaining a substantially constant volume within the cell, parametric test modules for receiving and analyzing the liquid stream before and/or after the liquid stream has passed through the liquid level cell, a parametric test module for receiving and analyzing the gas stream, and a data acquisition element for collecting parametric test data from the parametric test modules.

### BRIEF DESCRIPTION OF THE DRAWINGS

The disclosure will be more fully understood from the following detailed description, taken in connection with the accompanying drawings, in which:

FIG. 1 illustrates an embodiment of an apparatus that may be utilized in practicing one or more of the disclosed methods;

FIGS. 2A-2C illustrate embodiments of pulsation dampers that may be incorporated into systems and apparatus for practicing one or more of the disclosed methods;

FIG. 3 illustrates an embodiment of a pump controller that may be incorporated into systems and apparatus for practicing one or more of the disclosed methods;

FIGS. 4A-4C illustrate alternative embodiments of intake modules that may be incorporated into systems and apparatus for practicing one or more of the disclosed methods;

FIG. 5 illustrates an embodiment of a speed control circuit for pumps, including reagent pumps, that may be incorporated into systems and apparatus for practicing one or more of the disclosed methods; and

FIG. 6 illustrates an embodiment of a data acquisition configuration that may be incorporated into systems and apparatus for practicing one or more of the disclosed methods employed.

It should be noted that these Figures are intended to illustrate the general characteristics of methods, apparatus and/or systems utilized in certain example embodiments and to supplement the written description provided below. These drawings are not, however, to scale and may not precisely reflect the precise structural or performance characteristics of any given element or embodiment, and, accordingly, should not be interpreted as defining or limiting the range of methods, apparatus and systems that are fairly encompassed by the present disclosure.

### DETAILED DESCRIPTION

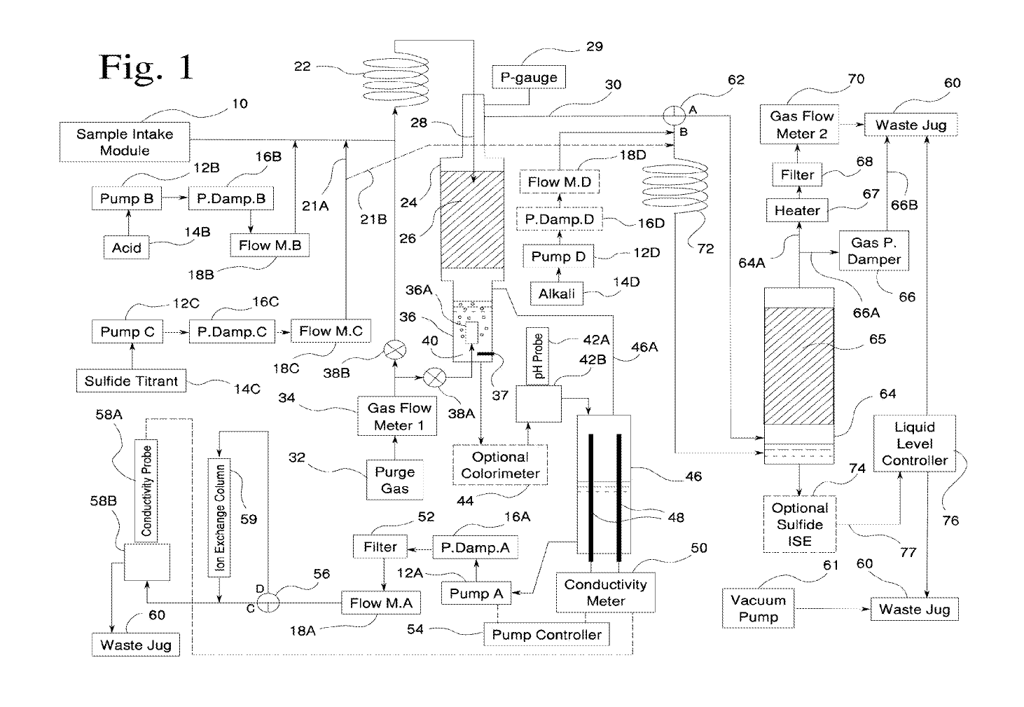

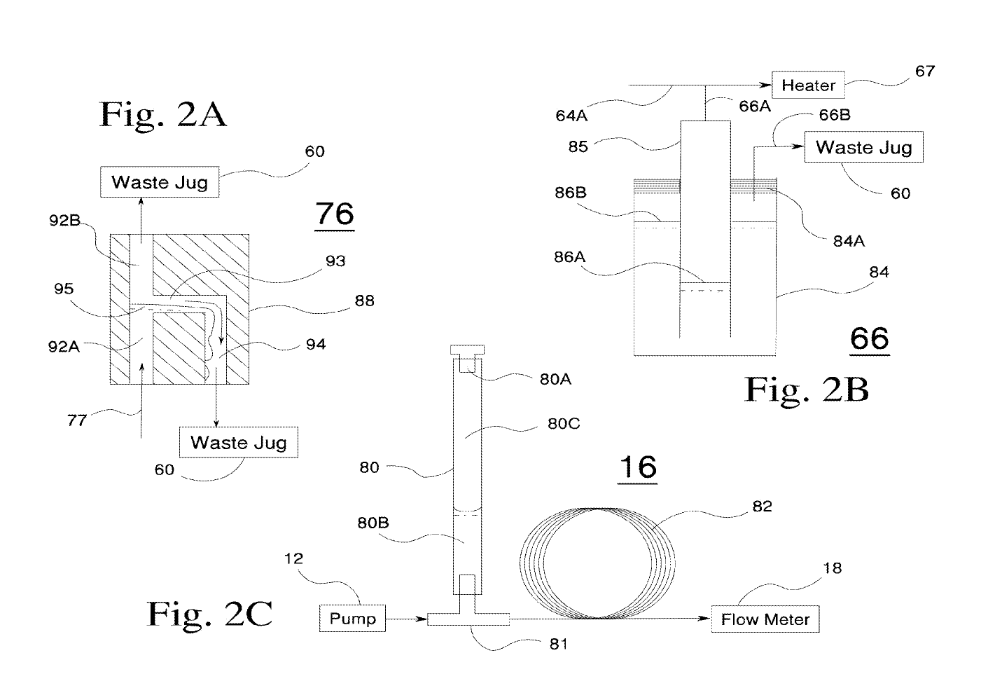

A first embodiment of an integrated analytical apparatus is illustrated in FIG. 1 with various embodiments of components and subsystems that could be incorporated in the integrated analytical apparatus being further illustrated in FIGS. 2A-C, 3, 4A-C, 5 and 6. As illustrated in FIG. 1, a sample or, more typically, a sample stream, enters the apparatus through one or more sample intake modules 10. As the sample stream exits the sample intake module 10, reagents, conditioners and other modifiers may be introduced into the sample stream. As illustrated in FIG. 1, one or more reagents including, for example, acidic solutions of known concentration and composition, may be maintained in a reservoir or other vessel 14B from which the solution is drawn using a pump 12B. The flow of the reagent stream may be modulated using one or more pulsation dampers 16B and/or mass flow controllers 18B in order to provide improved control of the rate at which the reagent from reservoir 14B is introduced into the sample stream. As illustrated in FIG. 1, additional reagents including, for example, a sulfide titrant solution may be maintained in other reservoirs 14C from which they are drawn by a dedicated 12C or shared (not shown) pump from which the additional reagent stream may pass through one or more pulsation dampers 16C and/or mass flow controllers 18C in order to provide improved control of the rate at which the additional reagent(s) from other reservoir(s) 14C are introduced into the sample stream.

As noted above, one or more of the reagents that may be introduced into the sample stream may include acidic solutions necessary for performing one or more of the desired analytic tests. A dilute acidic solution, for example a 0.01M sulfamic acid containing an effective amount of a visual pH indicator solution, may be utilized in titrating ammonia present in the condensate fraction of the sample stream. One pH indicator solution that may be used in the dilute acidic solution comprises a mixture of bromocresol green and methyl red which provides a sharp transition point at about pH 4.2 that is useful in an ammonia titration. Similarly, a more concentrated acidic solution, for example a 0.1M sodium hydrogen sulfate solution, may be used for acidifying the condensate fraction of the sample stream in connection with a sulfide titration. This more concentrated acidic solution also preferably contains a quantity (preferably about 200 mg/L) of soluble starch sufficient to provide a visible endpoint for the iodometric titration of sulfide.

As noted above, in addition to the acidic solutions, other reagents can be introduced into the sample stream as necessary to condition the stream for subsequent analysis. For example, in connection with a iodometric titration of sulfide, a second reagent solution, for example a 0.005M solution of iodine (0.010N) that also contains a quantity of potassium iodide sufficient to keep the iodine in solution, may be used in conjunction with a sodium hydrogen sulfate solution or other suitable solution for analyzing the sulfide concentration in the sample stream. As will be appreciated by those skilled in the art, the range of reagants and the particular configuration of the apparatus illustrated in FIG. 1 may be readily adapted for a wide range of test procedures. For example, rather than the iodine solution a 0.01M solution of zinc acetate and/or zinc sulfate may be used to determine sulfide concentration by potentiometric titration in combination with a sulfide ion specific electrode (ISE).

As noted above the configuration of the apparatus illustrated in FIG. 1 may be adapted as necessary for conducting a number of analytical tests. In connection with sulfide testing for example, the selected sulfide titrant solution maintained in reservoir 14C may be introduced into the sample stream through flow path 21A in connection with a first sulfide titrant solution (including, for example, the iodine+potassium iodide solution detailed above) in conjunction with iodometric titration. Alternatively, the sulfide titrant solution (for example, the zinc acetate and/or zinc sulfate solution detailed above) may be introduced into the sample stream through flow path 21B in conjunction with potentiometric titration.

As illustrated in FIG. 1, the sample stream, which has now been modified by the introduction of one or more reagents from reservoirs 14B, 14C, is introduced into reaction coil 22 in which the sample stream and the added reagents will be thoroughly mixed. As will be appreciated by those skilled in the art, the reaction coil may be utilized in a number of configurations so long as the combination of the flow rate through the reaction coil and the internal configuration of the reaction coil are sufficient to provide mixing adequate to produce a generally homogeneous solution and provide sufficient time for any desired chemical reaction between the sample stream and the reagent solution(s).

One example configuration for the reaction coil comprises at least two feet (61 cm) of ⅛ inch ID (3.2 mm) plastic tube (preferably polyethylene) with a turbulence promoting element inside. The turbulence promoting element can be made by threading a length of 0.062 inch (1.57 mm) stainless steel welding rod through an 8 inch (20.3 cm) length of a ⅛ inch (3.2 mm) OD continuous stainless steel spring, and stretching and deforming the spring to at or near its maximum possible length with the welding rod inside. At least one end of the stretched spring can then secured to the welding rod by, for example, spot-welding to form a stable turbulence promoting structure that can then be inserted into the plastic tube. As will be appreciated by those skilled in the art, the necessary mixing may be achieved with configurations in addition to the reaction coil including, for example, small vessels or channels that are stirred or otherwise agitated to sufficient degree.

The mixture of the sample stream (including both condensate and gas components) and the titrating reagent(s) then exit the reaction coil and enters the gas stripping column 24 through tube or flow path 28 that may comprise, for example, a small diameter tube such as preferably ⅛ inch (3.2 mm) OD stainless steel tubing which extends a short distance into the packed part 26 of the column in order to reduce carryover of spray.

As will be appreciated, the gas stripping column 24 may be utilized in a variety of configurations depending on a number of variable including, for example, flow rates, packing materials, differential pressure and reaction times. One configuration that is considered suitable for practicing the disclosure methods includes a larger diameter upper part, preferably about 0.75 inch (1.9 cm) ID, about 8 inches (20.3 cm) long. It also preferred that the gas stripping column be transparent or be provided with longitudinally arranged transparent regions so that the performance of the column may be observed for flooding or other undesirable conditions. The packing 26 provided within the gas stripping column 24 may comprise a plurality of white ceramic balls of diameter about 0.2 inches (5.1 mm). A digital pressure-vacuum gauge 29 may be provided near the top of the gas stripping column, preferably electronic with visual display and analog output, to allow further monitoring of the performance of the column.

Gas reaching the top or head of the gas stripping column 24 may be withdrawn through gas discharge line 30, a point that is preferably located well above the point at which the mixture of sample and reagent enters the column and may be particularly configured for reducing the passage of entrained spray into the discharge line. The purge gas source(s) 32 available for introduction into the gas stripping column may include air provided through a small air pump and gas flow pulsation damper (not shown) (suitable for iodometric titration of sulfide) and/or cylinder(s) of argon and/or another inert gas(es) can also be used (preferred when potentiometric titration of sulfide is utilized). The purge gas may be metered into the gas stripping column 24 through one or more gas flow meters 34 and may be feed into the top, bottom or both of the gas stripping column as determined by the settings of valves 38A, 38B. The gas flow meter may, for example, comprise a thermal flow meter (which gives a response proportional to moles of gas weighted by the molar heat capacity of the gas) capable of a flow range of 0-1,000 ml/min.

The purge gas can then be fed into the lower portion or gas purge chamber 36 of the gas stripping column 24 through a gas dispersion frit 36A, preferably sintered glass or sintered stainless steel, or other nozzle or eductor. The gas purge chamber 36 may comprise a segment of transparent glass or plastic tubing ⅝ inch (15.9 mm) ID and about 2 inches (5.1 cm) long, thereby allowing the color of the mixture of the condensate portion of the sample stream and reagent solution(s) 40 to be visually monitored as it is stripped of dissolved gases. The temperature of the solution may be monitored using a temperature probe 37, for example, a resistance temperature detection (RTD) element. As illustrated in FIG. 1, metering valve 38A can be used to control the flow of purge gas through gas dispersion frit 36A while metering valve 38B can be used to control the flow of purge gas added to the mixture of the sample stream and reagent(s) before the mixture enters reaction coil 22.

As illustrated in FIG. 1, the degassed mixture of condensate and reagent(s) can be withdrawn from the gas purge chamber 36 and subjected to further parametric testing including, for example, a colorimetric analysis in a colorimeter 44. The colorimeter, if utilized, will preferably be capable of substantially simultaneous measurement of optical density at two or more wavelengths utilizing light emitting diodes and solid state photodetectors. The degassed mixture of condensate and reagent(s) can also be subjected to pH testing in which the liquid withdrawn from the gas purge chamber passes through a flow-through probe cell 42B comprising, for example, a machined plastic block, that is designed and operated to force the flow of liquid up and around the active tip of the pH probe 42A. As will be appreciated, analytical tests which do not substantially alter the characteristics of the degassed mixture of condensate and reagent(s) can be performed in various sequences or, depending on the flow volume, can be performed using parallel flow paths so that one or more of the test elements can be taken offline for servicing without interfering with a “downstream” test element.

As illustrated in FIG. 1, the apparatus also includes a liquid level sensing cell 46 that may, for example, comprise a transparent glass or plastic tubing ⅝ inch (1.6 cm) ID and about 4 inches (10.2 cm) long. Small diameter tubing 46A can be used for connecting the liquid level sensing cell to the gas purge chamber, thereby allowing the pressure to be equalized between gas purge chamber 36 and liquid level cell 46 which is connected to each of them at a point safely above the liquid levels therein. As will be appreciated, the liquid level within the liquid level cell 46 may be satisfactorily controlled using a number of known techniques and mechanisms, the details of which are readily known to those skilled in the art. One preferred method illustrated in FIG. 1 utilizes the conductance of the liquid within the cell as measured between two or more electrodes 48 comprising, for example, ⅛ inch (3.2 mm) stainless steel rods. As the liquid level within the cell changes, there will be a corresponding change in the conductance measured between the two electrodes by the conductivity meter 50.

Pump controller 54 is configured to respond to the conductance measured by the conductivity meter 50 and adjust the flow rate through pump 12A in order to maintain a substantially constant volume within liquid level cell 46. As detailed above, the output of pump 12A may be modulated using one or more pulsation dampers 16A and/or mass flow controllers 18A in order to provide improved control of the rate at which the liquid from liquid level cell 46 is introduced into the downstream measurement elements. The pump 12A used for extracting the treated condensate may, for example, be configured as a variable speed peristaltic pump while the liquid flow meter 18A may, for example, be configured as a turbine (Pelton wheel) type meter that incorporates an optical sensor and provides for a flow rate in the range of 0-100 mL/min.

As also illustrated in FIG. 1, one or more filters 52 may be provided between the liquid level cell 46 and downstream measurement elements and may, for example, comprise one or more perforated plastic filter elements characterized by a pore size of about 60 μm provided in corresponding filter housings.

As illustrated in FIG. 1, the apparatus may include other reagent reservoirs 14B used in treating and/or modifying the gas removed from the head of the gas stripping column 24 through discharge line 30. For example, reservoir 14B may include an alkali solution that can be combined with the gas stream for absorbing a portion of the carbon dioxide. This alkali solution can be extracted and fed into line 30 using a pump 12D, the output of which may be modulated using one or more pulsation dampers 16D and/or mass flow controllers 18D in order to provide improved control of the rate at which the alkali solution is introduced. The alkali solution may include, for example, a 1N solution of NaOH and/or one or more additional alkali compounds such as LiOH, NaOH or KOH for absorbing carbon dioxide. Preferably, the alkali solution will also contain an effective amount of at least one pH indicator dye such as, for example, thymolphthalein, selected for the visible and distinct indication of an alkaline pH.

The liquid flow from pump 12A will eventually reach a three way valve 56 configured with exit ports C and D for selectively routing the treated condensate into an ion exchange column 59 from which the condensate will enter the conductivity probe cell 58B where it will be exposed to a conductivity probe 58A that may, for example, include platinum surfaced electrodes and exhibit a cell constant of 0.1. As will be appreciated, the conductivity probe cell 58B may be configured in a manner similar or even substantially identical to the pH probe cell 42B for ensuring sufficient contact between the condensate flow and the conductivity probe.

The ion exchange column 59 may, for example, be packed with one or more strongly acidic cation exchange resin(s) in H+ form with the output of the conductivity probe cell 58B being discharged into a waste jug 60 that may, for example, comprise a heavy walled plastic jug providing a volume of about 2 gallons (7.6 liters) volume and having a closed or closeable top. Although not required, maintenance of the apparatus may be simplified if most or all of the waste streams exiting the apparatus—both liquid and gas—are discharged to a single waste jug having sufficient capacity to support the intended operation of the apparatus as illustrated in FIG. 1.

A vacuum pump may be provided in connection with waste jug 60 that will permit the apparatus as illustrated in FIG. 1 to be operated in a manner whereby the discharge portions of the system including, for example, waste jug 60, a maintained at sub-atmospheric pressure using a vacuum pump 61 to produce a pressure differential across the system whereby a sample stream entering the system at near atmospheric pressure is exposed to a pressure gradient that tends to needs to urge the sample streams, and the separated the liquid and gas streams, to flow reliably through the system.

As illustrated in FIG. 1, a three way valve 62 having exit ports A and B may be provided in gas discharge line 30 for directing the gas flowing through gas discharge line 30 through a second reaction coil 72 and then into the lower part of phase separation column 64 or, during periods when no additional reaction is necessary including, for example, certain periods of operation and/or during startup and shutdown, the gas could be fed directly into the lower part of phase separation column 64 without passing through the reaction coil. Typically, as the gas and the reagents pass through the second reaction coil the alkali solution will be absorbing carbon dioxide. Although, as will be appreciated by those skilled in the art, a number of reaction coil designs may be utilized for providing sufficient mixing and reaction duration to ensure substantially complete absorption of carbon dioxide by reaction with alkaline solution from reservoir 14D. In light of the reduced reaction rate associated with the absorption, the second reaction coil 72 may be constructed in a manner generally consistent with that utilized in reaction coil 22. The second reaction coil will preferably be about twice as long as the first reaction coil in order to allow sufficient time for the generally slow absorption kinetics of carbon dioxide adsorption in an alkali solution to approach completion.

The construction of the phase separation column 64 may be similar to that of gas stripping column 24. A discharge tube 64A is provided at that head of phase separation column 64 above the packed section 65 which functions as a mist catcher. The packed section may be packed with a variety of materials including, for example, 5 mm Raschig rings comprising 5 mm long cut pieces of thin walled borosilicate glass tubing. The discharge tube may be connected through a branch tube or connection 66A to a gas pulsation damper 66 for stabilizing the gas flow entering the gas flow meter 70 with the headspace of the gas pulsation damper being, in turn, connected to a waste jug 60 through pressure equalizing tube 66B.

As illustrated in FIG. 1, the stabilized gas flow then enters heater 67, the heater being configured to provide heat transfer sufficient to evaporate any remaining mist or droplets of entrained liquid that may be present in the gas flowing out of phase separation column 64. One heater configuration comprises segments of stainless steel tubing passing through and in good thermal contact with an aluminum block that is, in turn, in contact with an electric heating element (not shown) with the heater assembly being covered with insulation of sufficient thickness, performance and configuration to reduce or prevent unwanted heating of adjacent elements of the apparatus and improve safety for those operating the apparatus. A gas filter 68 that may, for example, comprise a membrane filter having a 5-10 μm pore size and a 25 mm diameter with Luer connector fittings, can be provided downstream of the heater to remove larger particulate matter before the gas enters the gas flow meter 70 for sample gas, preferably of corrosion resistant construction, but otherwise similar to purge gas flow meter 34.

As further illustrated in FIG. 1, the apparatus may include a sulfide ion-specific electrode (ISE) 74 installed in an appropriate cell holder and used in potentiometric titration of sulfide. A liquid level controller that may also provide antisiphon features and functionality as illustrated in more detail with respect to the mechanisms in FIG. 2. A connecting tube 77 and water flow into liquid level controller and antisiphon 76 that is typically operated to maintain sufficient liquid level within the phase separation column 64.

Although, as will be appreciated, the antisiphon element may be manufactured in a range of functional configurations. One such embodiment is illustrated in FIG. 2A, in which the antisiphon element 76 comprising a body 88, preferably a machined block of transparent acrylic plastic, through which is defined a lower part 92A of first vertical channel through which a stream of water or other liquid 77 enters liquid level controller 76. The first vertical channel continues through an upper part 92B and exits the body 88. Additional tubing and/or channels may be provided for directing any fluid exiting 92B to waste jug(s) 60 to prevent siphoning in the event upstream pressure is reduced and/or there is an increase in pressure within the waste jug(s). Also within the body 88 are provided a horizontal bore 93 and a second vertical bore 94 through which water 95 can overflow from the first vertical bore through horizontal bore 93 to second vertical bore 94 and out to one or more waste jug(s).

Illustrated in FIG. 2B is an embodiment of gas pulsation damper 66 comprising a main vessel 84, preferably a 1 L, heavy walled, wide mouth glass jar or its equivalent that is sealed with an air tight cover 84A, preferably a large rubber stopper with the necessary holes drilled through it. The illustrated embodiment of the gas pulsation damper 66 further includes an inner chamber 85 of gas pulsation damper that may, for example, be fabricated from a length of transparent 1 inch (2.5 cm) PVC pipe, closed at the upper end and open at the lower end. As will be appreciated, the liquid level 86A of the fluid contained within the inner chamber 85 and the liquid level 86B found in the main outer chamber can be quite different. The gas pulsation damper is, in turn, fluidically connected to both discharge tube 64A through branch tube 66A and to waste jug 60 through pressure equalizing tube 66B to suppress flow and/or pressure variations in the gas entering the heater 67.

As illustrated in FIG. 2C is a liquid pulsation damper 16 that may be used in connection with any of the pumps 12A, 12B, 12C or 12D identified in FIG. 1 as the corresponding dampers 16A, 16B, 16C or 16D in conjunction with any one of liquid flow meters 18A, 18B, 18C or 18D. As illustrated in FIG. 2C, the damper may include an accumulator tube 80, preferably ⅛ inch (3.2 mm) ID×¼ (6.4 mm) OD vinyl tubing, about 8 inches (20.3 cm) long, that may be sealed by plug 80A or a cap to close the free end of accumulator tube 80 to form a gas head space 80C that is compressed as the liquid column 80B rises into the accumulator tube in response to the increased pressure when pump 12 is activated. A “T” tube fitting 81 may be used to connect the accumulator tube 80 to pump 12 and damper coil 82 that may, for example, comprise a segment of vinyl tubing, preferably 1/16 inch (1.6 mm) ID×⅛ inch (3.2 mm) OD and about 3 feet (91 cm) long. Acting in combination, the accumulator tube 80 and the damper coil 82 tend to suppress pump-induced flow and/or pressure variations in the liquid entering the flow meter 18.

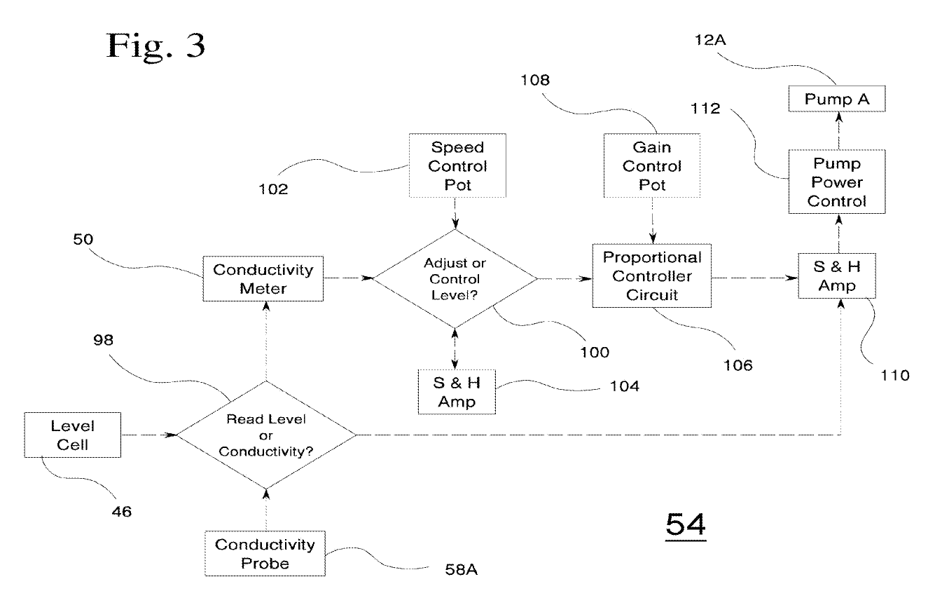

An embodiment of a pump controller 54 is illustrated in FIG. 3, in which a first control switch or relay 98, for example, a DPDT switch, may be provided for selecting between reading conductance of level cell 46 or conductivity probe 58A. The second channel of the switch may be configured for locking the output voltage of sample and hold amplifier 110 will reading the conductivity at probe 58A. A second control switch or relay 100 may be provided for selecting between adjusting the water level in level cell 46 using pump speed control potentiometer 102, used to adjust the steady state water level in level cell 46, or controlling the water level through the output of proportional control circuit 106, used for generating a control voltage that adjusts the output of condensate pump 12A as needed to maintain a constant water level in level cell 46.

As illustrated in FIG. 3, a first sample and hold amplifier 104 may be used for storing the voltage level corresponding to the water level desired when control switch 100 is set to “control level.” A gain control potentiometer 108 may be provided for determining the magnitude of the response of proportional controller circuit 106 in relation to changes in the conductance of level cell 46 which, in turn, is proportional to the water level in level cell 46. A second sample and hold amplifier 110 may be provided for storing and relaying the output of proportional controller circuit 106 to pump power control circuit 112 while the conductivity meter 50 is being used for reading the conductance of conductivity probe 58A instead of reading the conductance of level cell 44. The pump power control circuit 112 may be configured for imposing a voltage across the motor of condensate pump 12A which is approximately proportional to the control voltage generated by proportional controller circuit 106 and may, for example, comprise a power operational amplifier (OpAmp) or a functional equivalent.

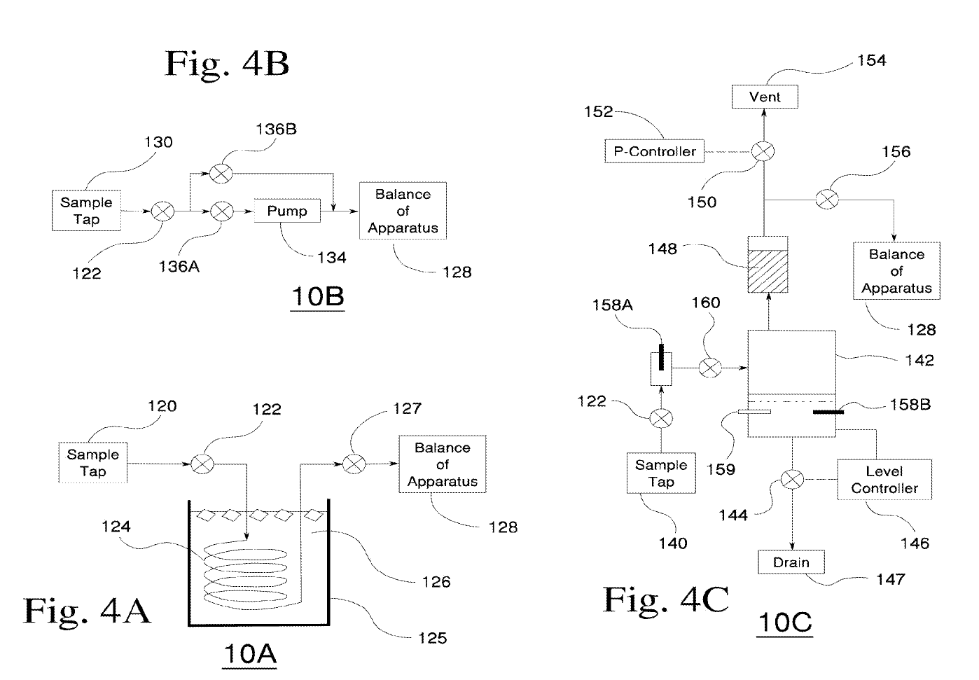

As illustrated in FIG. 4A, a first embodiment of a sample intake module 10A may comprise a sample tap 120 on steam pipe with an inlet valve 122, for example a needle valve, for controlling steam flow into the condensing coil 124, for example a ⅛ inch (3.2 mm) OD thin walled stainless steel pipe about 3 feet (91 cm) long, that may be submerged in a reservoir, bucket or other vessel 125 that contains a heat transfer fluid, for example, a mixture of water and ice, that will tend to condense a portion of the steam flow as it passes through condensing coil 124. The condensate, along with any remaining vapor and/or NCG can then be fed into the balance of the apparatus 128 through a flow control valve 127, preferably a needle valve.

As illustrated in FIG. 4B, a second embodiment of a sample intake module 10B may comprise a sample tap 130 on a condensate line, a pump 134, for example, a peristaltic pump, for increasing the pressure of the condensate before it is fed into the balance of the apparatus, a valve 136A which is open when sampling condensate at low pressure to direct the condensate flow through pump 134 and a valve 136B which is open when sampling condensate at pressure high enough for the sample to flow into the balance of the apparatus without being assisted by pump 134.

As illustrated in FIG. 4B, a third embodiment of a sample intake module 10C that may have particular utility in analyzing stream from a geothermal brine line operating at elevated pressures may comprise a sample tap 140 on brine line, a flash separator vessel 142, for example a small cyclonic separator, a brine outlet valve 144, a water level controller 146 which operates valve 144 as needed to maintain approximately constant water level inside flash separator vessel 142, a drain 147 which receives the flashed brine, a mist catcher 148, preferably a serpentine baffle type, a steam release valve 150, preferably an adjustable, electrically actuated needle valve, a pressure controller 152 which operates steam release valve 150 to maintain constant pressure inside of flash separator vessel 142, a steam vent 154 to atmosphere, and a control valve 156 for controlling the steam flow rate into balance of apparatus 128.

As further illustrated in FIG. 4C, the sample intake module 10C may also comprise a first temperature probe 158A for measuring the temperature of the unflashed brine, a second temperature probe 158B for measuring the temperature of the flashed brine, a conductivity probe 159 for measuring the conductivity of the flashed brine, and a control valve 160 for restricting flow so as to ensure existence of a liquid phase only upstream of this valve.

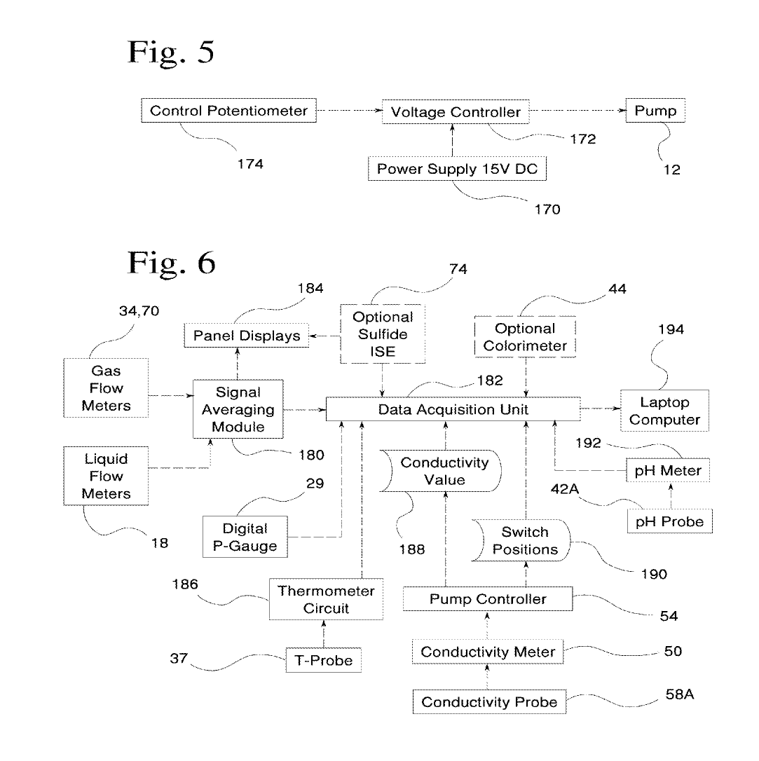

An embodiment of a pump speed control circuit suitable for use with reagent pumps 12B, 12C and 12D is illustrated in FIG. 5, and comprises a main power supply 170, for example a 10 A power supply operating at 15 VDC maximum output, a voltage control circuit 172 and a potentiometer 174 used for setting output voltage of control circuit 172 and therefore the speed and output of pump 12.

An embodiment of a general scheme or system for acquiring analytical data from embodiments of the disclosed apparatus is illustrated in FIG. 6 and comprises a signal averaging module 180 receives analog signals from gas flow meters 34 and 70, and liquid flow meters 18, a data acquisition unit 182 receives time averaged gas flow rate and water flow rate signals from signal averaging module 180, a digital panel 184 for displaying selected data including, for example, substantially instantaneous and/or time averaged gas flow and water flow signals from signal averaging module 180, a thermometer circuit 186 configured for calculating condensate temperature based on the resistance of one or more temperature probe(s) 37 and transmitting temperature data as an analog signal to data acquisition unit 182, and a conductivity value 188 as determined by conductivity meter 50 that is transmitted to data acquisition unit 182 by pump controller 54.

Similarly, switch position data 190 with respect to the position of switches 98 and 100 within pump controller 54 may be transmitted to data acquisition unit 182 as “on-off” voltage values and a pH meter 192 may transmit the sensed value of the condensate pH as an analog voltage signal to data acquisition unit 182. The data acquisition unit 182, in turn, transmits the accumulated parametric and status data to a laptop or minicomputer 194 where the data is used in calculating derivative chemical and physical parameters and values that may be stored, displayed and/or transmitted as calculated values, raw data and switch settings and/or one or more summary analytical report(s).

As noted above, the embodiment of the analytical apparatus as illustrated in FIG. 1 may be configured and/or operated for determining and tracking the values of several analytical quantities of interest. As will be appreciated by those skilled in the art, the apparatus illustrated in FIG. 1 can be modified for conducting certain of the analytical tests in a variety of sequences and may, for example, provide for parallel processing of condensate samples through different test modules. Accordingly, while the particular sequence of tests detailed below may be preferred, this particular sequence may be modified by reordering, adding or deleting certain of the tests without departing from the invention.

### Operation of the Apparatus

Further, it should be understood that while the procedures detailed below may be described in a manner that suggests manual operation of the apparatus and manual recordation of the various measurements, the data should preferably be collected using data acquisition unit 182 and laptop computer 194 as illustrated in FIG. 6. Indeed, it is preferred that the laptop computer 194 be configured or configurable with a range of software applications necessary to perform the various calculations outlined below and to generate one or more detailed and/or summary analytical report. Similarly, it is preferred that the laptop computer be provided with or connected to memory capacity sufficient for storing a reasonable amount of historical analytical data. One skilled in the art would also know how to automate operation of the apparatus, controlling it from a laptop computer or another cybernetic device.

### Total Non-Condensable Gas Ratio, pH and Conductivity of the Condensate

“Total NCG” or “NCG Ratio” refers to the weight or number of moles of the vapor phase remaining in contact with the condensate at ambient temperature and pressure after the steam is condensed with no attempt made to correct for the amount of gas dissolved in the condensate or the amount of water vapor in vapor phase. Typically, the value is expressed in terms of weight percent or mole percent in relation to the condensate.

To determine NCG ratio in a steam sample using steam sampling module 10A illustrated in FIG. 4, power on the apparatus and open valve 122 to start the flow of condensate and residual vapor into the main apparatus illustrated in FIG. 1. Do not turn on purge gas at this time. Set 3-way valves 56 and 62 to exit ports C and A respectively. Set switch 98 to “read level.”

Set switch 100 to “adjust level.” When condensate appears in level cell 46, adjust speed control potentiometer 102 as needed to maintain a stable water level inside of level cell 46. Then set switch 100 to “control level.”

When all readings have stabilized, record gas flow through gas flow meter 70 and condensate flow through liquid flow meter 18A. The ratio of these values will be proportional to the NCG ratio. (Note: the response of a thermal gas flow meter is proportional to the number of moles of gas per minutes weighted by the molar heat capacity of each gas at constant pressure. Therefore, an average heat capacity for the mixture of gases needs to be estimated in order to convert the NCG ratio to mole percent, and an average molecular weight needs to be estimated in order to convert the NCG ratio to weight fraction.)

Record condensate pH. Briefly set switch 98 to “read conductivity,” record the conductivity value and condensate temperature, then reset switch 98 to “read level.”

### Hydrogen Chloride

Set 3-way switch 56 to exit port D, forcing condensate to flow through ion exchange column 59 before it enters conductivity probe cell 58B. Read and record conductivity and condensate temperature. Repeat conductivity reading as necessary until the conductivity reading is stable. Finally, set 3-way switch 56 back to exit port C to conserve the resin in the ion exchange column.

The strongly acidic cation exchange resin in column 59 will replace all cations in the condensate with protons, thereby converting bicarbonate and hydrogen sulfide ions in the condensate to carbon dioxide and hydrogen sulfide. The chloride ion in the condensate will remain as hydrogen chloride, HCl. In the absence of brine carryover or another source of salts of cations other than ammonium, HCl will be the only electrolyte present in the condensate, whereby the measured conductivity of the condensate will be approximately proportional to the amount of chloride in the condensate.

The measurement of HCl is subject to interference by nonvolatile salts (for example sodium chloride and sodium sulfate) that may be present due to brine carryover or other sources of contamination. These salts will be converted to the corresponding acids and will contribute to the measured conductivity together with the HCl initially present in the steam. In this case, the conductivity reading recorded will be approximately proportional to the total number of equivalents of HCl, sulfuric acid and any other strong acids that may be present in the sample analyzed.

### Ammonia

The major electrolytes present in the condensate from steam without brine carryover will be the ammonium salts of carbon dioxide, hydrogen sulfide and boric acid, all three of which are weak acids. The mole sum of these three anions can be determined as the total alkalinity of the brine to the methyl red endpoint, approximately pH 4.2. If chloride is present, it will primarily be in the form of ammonium chloride, and the ammonia associated with chloride will not register as part of the titre. The total amount of ammonia in the sample analyzed can be determined according to Equation I as:

Ammonia(moles)=Alkalinity(equivalents)+Chloride(moles) I

Determine alkalinity by titrating the condensate using 0.010N sulfamic acid or another dilute solution of a strong acid from reservoir 14B with accurately known concentration. Adjust the flow rate of pump 12B until the pH of the condensate as measured by pH probe 42A is stable within the range 4.0 to 4.5, and preferably about 4.2. Record the flow rates at flow meters 18A and 18B. The concentration of ammonia in the condensate is then determined by Equation II:

C(ammonia,M)=C(chloride,N)+C(Acid,N)×Flow(18B)/(Flow(18A)−Flow(18B)) II

The end point of the titration can conveniently be noted visually by adding a suitable amount of a pH indicator dye composition to the acidic solution from reservoir 14B; for example, a combination of bromocresol green and methyl red which has a sharp transition near pH 4.2. The operator will be able to detect the approximate location of the endpoint as a function of flow rate measured by flow meter 18B by noting the characteristic mixed color at the transition value of pH as observed inside the transparent gas purge chamber 36. If optional colorimeter 44 is provided, the endpoint will be indicated by the appropriate ratio of absorbance at two wavelengths which are representative of absorbance by the indicator dye composition above and below the transition pH value of the indicator dye composition employed.

### Hydrogen Sulfide Using Iodometric Titration

In this case, the acidic solution from reservoir 14B should be a 0.1N solution of a fairly strong acid, preferably a 0.1M solution of sodium hydrogen sulfate also containing an effective amount of soluble starch, preferably about 200 mg/L. Sulfide titrant solution from reservoir 14C should preferably be a 0.005M solution of iodine also containing sufficient potassium iodide to keep the iodine in solution, and sulfide titrant solution from reservoir 14C should be added to the condensate by route 21A; that is, before reaction coil 22. Adjust pump 12B to give a stable condensate pH of 3 or lower. Adjust pump 12C until dark blue color indicative of excess iodine is visible in column packing 26 and gas purge chamber 36. Due to small variations in mixing of the condensate with sulfide titrant solution from reservoir 14C, the color of the liquid will fluctuate rapidly between blue and clear at the equivalence point. Record condensate flow at flow meter 18A and sulfide titrant flow at flow meter 18C. The concentration of hydrogen sulfide in the condensate may then be determined using Equation III:

C(Sulfide,M)=C(Iodine,M)×Flow(18C)/(Flow(18A)−Flow(18B)−Flow(18C)) III

The endpoint can also be determined electronically, using optional colorimeter 44 to note the color change.

### Carbon Dioxide Plus the Unreactive Gases

The sum of carbon dioxide and the unreactive gases (hydrogen, argon, etc.) is determined by acidifying the condensate and purging it to strip out dissolved gases while eliminating hydrogen sulfide by reaction with iodine. Mass transfer of dissolved gases to the gas phase is accomplished in three steps. First, gases partition between liquid and gas inside reaction coil 22, and are separated when the mixture of liquid and gas enters gas stripping column 24. The liquid then flows down through column packing 26, where it meets a counter flowing stream of the purge gas. Finally, the liquid is purged with gas bubbles from frit 36A in gas purge chamber 36.

Most conveniently, this analysis should be performed immediately after determining sulfide by iodometric titration, starting with the apparatus in its condition existing at the end of the iodometric titration procedure.

Maintain the flow rate of acidic solution from reservoir 14B as needed to maintain condensate pH at 3 or lower. Adjust pump 12C to increase flow of sulfide titrant from reservoir 14C to about 10% beyond the stoichiometric end point of the sulfide titration to establish and maintain a dark blue color inside gas purge cell 36.

If the volume of gas in the sample (as indicated by gas flow meter 70 before purge gas is turned on) is less than about 4 times the condensate volume, adjust control valve 38B to provide purge gas flow sufficient to raise the combined gas flow through gas flow meter 62 to a value which is 4 to 6 times greater by volume than condensate flow. (Condensate flow rate in mL/min, and flow rates of gases in mL/min referred to ambient temperature and pressure, which corresponds to the usual output of a thermal gas flow meter.) Adjust control valve 38A to provide purge gas flow (as indicated by gas flow meter 34) through frit 36A which is 4 to 6 times greater by volume than condensate flow. Record all liquid and gas flows and then apply Equation IV:

Condensate Flow=Flow(18A)−Flow(18B)−Flow(18C) IV

Correct gas flows determined by gas flow meters 34 and 70 by subtracting water vapor content which can be reliably estimated based on the temperature and pressure of the gas and then apply Equation V:

CO₂+Unreactive Gases=Corr.Flow(70)−Corr.Flow(34) V

### Unreactive Gases

Determine flow of CO₂+ nonreactive gases in the manner detailed above.

Switch 3-way valve 62 to redirect gas flow through exit port B leading to reaction coil 72, and turn on pump 12D to provide sufficient flow of alkali solution from reservoir 14D to ensure that the liquid effluent from reaction coil 72 remains highly alkaline as indicated by the color of the pH indicator dye in alkali solution from reservoir 14D.

Measure gas flow at meter 70 and correct it by subtracting the amount of water vapor. The corrected value will be sum of unreactive gases in the steam (that is, not including ammonia, hydrogen chloride, hydrogen sulfide or carbon dioxide), with mole numbers of the several unreactive gases weighted by the corresponding molar heat capacities at constant pressure.

### Carbon Dioxide

Subtract the corrected value for unreactive gases from the corrected value.

### Alternate Procedure for Gas Analysis

The sum of carbon dioxide, hydrogen sulfide and unreactive gases may be determined as follows, using an inert gas free of oxygen—preferably argon—as the purge gas.

Pump 12C is not used. Adjust pump 12B to provide 0.1M acid solution as needed to maintain condensate pH at 3 or lower. Adjust purge gas flows as described above. Measure the two gas flows, and correct the values obtained for water vapor content and then apply Equation VI:

CO₂+H₂S+unreactive gases=Corr.Flow(70)−Corr.Flow(34) VI

To determine unreactive gases, reset 3-way valve 62 to exit port B and pump alkali solution from reservoir 14D into the gas stream to scrub CO₂ and H₂S from the gas stream as described above.

To determine CO₂+H₂S, subtract the corrected value for unreactive gases from the corrected value for [CO₂+H₂S+unreactive gases].

To determine CO₂, subtract the value for H₂S determined by titration from the corrected value for [CO₂+H₂S].

### Alternate Procedure for Hydrogen Sulfide Using Potentiometric Titration

Potentiometric titration of sulfide may be achieved using a sulfide ion specific electrode 74 in combination with an inert, oxygen-free purge gas including, for example, helium, argon, neon, nitrogen or mixtures thereof.

Sulfide titrant solution from reservoir 14C preferably is a 0.01 M solution of zinc acetate and/or zinc sulfate with accurately known concentration. As will be appreciated, the titration can also be performed using salts of lead, cadmium or another metal forming an insoluble sulfide precipitate, but zinc salts are preferred because zinc is nontoxic and environmentally benign, and the reaction to form zinc sulfide exhibits accurate stoichiometry with no side reactions interfering.

Set pump 12B to acidify the condensate to pH 3 or below using a 0.1M solution of a strong acid. Set purge gas flows as described above to ensure thorough stripping of CO₂ and H₂S from the condensate. Combine sulfide titrant solution from reservoir 14C with the gas stream by way of alternate flow path 21B, that is, before the mixture enters the second reaction coil 72.

Stepwise and gradually increase the flow rate of sulfide titrant solution from reservoir 14C, allowing enough time between increments for the potential of the sulfide electrode 74 to stabilize, and record all flows and the potential of sulfide electrode 74 at each step. Plot the potential of sulfide electrode 74 against flow of sulfide titrant from reservoir 14C as read from flow meter 18C, and note the value of titrant from reservoir 14C flow that corresponds to the maximum slope of the curve. At this point, the moles of sulfide titrant delivered will be equal or substantially equal to the moles of H₂S in the sample.

### Analysis of Steam Condensate

Sample input module 10B is used to analyze steam condensate which contains dissolved gases with little or no vapor phase present. To sample condensate from a sample tap at sufficiently high pressure to flow through the apparatus without assistance of a pump, close valve 136A, and regulate sample flow by opening and adjusting needle valve 136B. To sample condensate at atmospheric pressure, close valve 136B, open valve 136A wide, and adjust pump 134 to provide the sample flow rate desired.

To analyze condensate or another liquid containing little gas, provide purge gas flow through each of control valves 38A and 38B equal to about 4 to 6 times the condensate flow.

### Gases Dissolved in Geothermal Brine

Use sample input module 10C to separate steam from the brine. Adjust control valve 160 to ensure that only a liquid phase exists upstream of this valve, and calculate the steam fraction as a function of the separator pressure and the temperatures of unflashed and flashed brine recorded using T-probes 158A and 158B, respectively. Note that knowledge of these three parameters allows the steam fraction to be calculated in two different ways, and that the calculation can be made more accurate by assuming that the brine has thermodynamic properties identical to a sodium chloride solution having the same conductivity at equal temperature instead of representing the brine by pure water.

### CONCLUSIONS AND RAMIFICATIONS

The inventions detailed herein represent novel solutions to the problem of providing a timely analysis of a two phase mixture of water and vapor to determine the amount of various volatile components that are distributed with widely varying proportions between the two phases and which exhibit wide variations in their chemical properties.

As detailed above, the apparatus and procedures disclosed allow the two phases present in the sample stream to be cleanly separated and moved under positive pressure through the apparatus. A control system coupled with devices for pumping water and/or aqueous solutions at a rate substantially equal to the rate at which the liquid phase enters the system is helpful in maintaining a smooth flow through the apparatus. In the preferred embodiment, this flow control function is provided by a liquid level sensing electrodes 48 inside of liquid level sensing cell 46 coupled to pump controller 54 that regulates pump 12A so as to maintain an essentially constant liquid level inside liquid level sensing cell 46. One skilled in the art will be able to substitute other means to provide the smooth flow required; for example, a flow sensor which measures and time averages flow rate of liquid 46A and a pump controller 54 that maintains the pumping rate of pump 12A equal to the average flow rate of liquid 46A.

As will be appreciated, the use of additional dampers and flow controllers also contribute to achieving a steady flow through the apparatus.

With the exception of chloride, all other chemical components are determined using measurements of gas flows or by titration, which is based on measuring liquid flows. As will be appreciated, the apparatus could easily be modified to provide a test module configured for measuring chloride by titration as well. Because the gas flow meters and liquid flow meters employed are easily calibrated and typically show little drift or error after being calibrated, reliance on gas and liquid flow measurements enables sufficiently accurate analyses to be performed in the field without requiring the laborious calibration procedures that other sorts of analytical transducers would require.

As will be appreciated by those skilled in the art, the method and apparatus as disclosed herein can be modified in many ways while remaining true to the spirit of the invention including, for example,

reducing the interfering contribution of CO₂+H₂S to the conductivity of the ion exchanged condensate exiting ion exchange column 59 by providing a secondary purge of the condensate using an inert gas or air before reading the conductivity;

as a first alternative to relying on conductivity as an indication of HCl content, the pH of the ion exchanged condensate can be measured instead of conductivity;

as a second alternative to relying on conductivity as an indication of HCl content, the ion exchanged brine can be titrated in a manner similar to that employed to determine the ammonia content of the condensate, using a basic solution as the titrant;

the composition of the mixture of “unreactive gases” that remains after CO₂+H₂S have been removed from the gas fraction by reaction with alkali from reservoir 14D can be determined using a gas chromatograph or a mass spectrometer; the fuel value of the NCG stream can be determined using a combustible gas analyzer;

the oxygen content of the NCG stream can be determined using an oxygen meter; a range of other reagent compositions and concentrations can be used instead of those described above;

3-way valve 62 may be removed to eliminate the option of bypassing reaction coil 72;

other kinds of gas and liquid flow meters can be utilized at one or more locations throughout the apparatus;

chloride in the condensate could be determined using a chloride ion specific electrode, a change which would eliminate the need for ion exchange column 59;

ammonium ion, ammonia and/or carbon dioxide concentrations could be determined using the corresponding specific electrodes; and/or.

the proportional controller circuit 106 used for controlling water level in level cell 46 could be replaced by another kind of control circuit including, for example, a proportional integral (PI) controller or a proportional integral derivative (PID) controller could be utilized for improving the controller response.

While the present disclosure has included descriptions of various embodiments of the apparatus, method and system, it should be understood that these embodiments are not intended to limit the disclosure and that one of skill in the art, guided by the present disclosure, can adopt the methods and apparatus disclosed to accommodate the testing of a wide range of parameters associated with mixed liquid/gas flows, whether such flows are produced naturally or during the course of an industrial process. Accordingly, the present disclosure is intended to encompass such alternatives, modifications, and equivalents as may be included within the spirit and scope of the appended claims.

I claim:

1. An integrated analytical system comprising:
an intake module configured for receiving a mixed stream of liquid and gas;
a pretreatment module configured for mixing a reagent with the mixed stream to form a treated stream;
a gas purge module for receiving the treated stream and mixing the treated stream with a first purge gas, wherein the gas purge module separates the treated stream into a liquid stream and a gas stream;
a liquid stream flow controller for modulating the flow from the gas purge module;
a first parametric test module for receiving and analyzing the liquid stream;
a second parametric test module for receiving and analyzing the gas stream; and
a data acquisition assembly for collecting parametric test data from the first and second parametric test modules.
